(19) United States
(12) Patent Application Publication
(10) Pub. No.: US 2011/0139726 A1
(43) Pub. Date: Jun. 16, 2011

(54) FILTRATION MEDIA COATED WITH ZERO-VALENT METALS, THEIR PROCESS OF MAKING, AND USE

(76) Inventors: YAN JIN, Newark, DE (US); PEI CHIU, Hockessin, DE (US)

(21) Appl. No.: 12/964,998

(22) Filed: Dec. 10, 2010

Related U.S. Application Data
(60) Provisional application No. 61/285,299, filed on Dec. 10, 2009.
(60) Provisional application No. 61/356,902, filed on Jun. 21, 2010.
(60) Provisional application No. 61/364,251, filed on Jul. 14, 2010.

(51) Int. Cl. C02F 1/68; B01D 35/28; C02F 1/30; B05D 3/02; B05D 3/04

(52) U.S. Cl. 210/748.08; 210/490; 210/435; 210/764; 427/383.1; 427/377

(57) ABSTRACT

The present invention generally relates to filtration media for treating fluids, particularly water. In one aspect, the invention relates to the filtration media coated with nano-sized, zero-valent metals. In another aspect, this invention relates to the processes for making such nano-sized, zero-valent metal-coated filtration media. In yet another aspect, the invention relates to removing microbiological impurities such as microbial pathogens from water by treating the water with filtration media that include nano-sized zero-valent metals. In another aspect, the invention relates to a device comprising such nano-sized, zero-valent metal-coated filtration media for treating water.

### CROSS-REFERENCE TO RELATED APPLICATION

This application claims priority to the following provisional applications, all of which are incorporated by reference herein in their entirety:
(1) U.S. Provisional Application No. 61/285,299; filed Dec. 10, 2009;
(2) U.S. Provisional Application No. 61/356,902; filed Jun. 21, 2010; and
(3) U.S. Provisional Application No. 61/364,251; filed Jul. 14, 2010.

### FIELD OF INVENTION

The present invention generally relates to filtration media for treating fluids, particularly water. In one aspect, the invention relates to the filtration media coated with nano-sized, zero-valent metals. In another aspect, this invention relates to the processes for making such nano-sized, zero-valent metal-coated filtration media. In yet another aspect, the invention relates to removing microbiological impurities such as microbial pathogens from water by treating the water with filtration media that include nano-sized zero-valent metals. In another aspect, the invention relates to a device comprising such nano-sized, zero-valent metal-coated filtration media for treating water.

### BACKGROUND

Microorganisms pathogenic to humans are found in all types of waters including drinking water. Major groups of microbial pathogens include viruses, bacteria, and protozoa. Sources of microbial contamination include, but are not limited to, leaking septic tanks and sewer lines, waste-water discharge and reuse, landfills, and sewage sludge application on land, as well as runoff and infiltration from animal waste-amended fields. According to the United States Environmental Protection Agency, contaminated drinking water is one of the highest-ranking environmental risks and microbial contaminants are likely the greatest health-risk management challenge for drinking-water suppliers Illnesses from microbial pathogens range from mild or moderate cases lasting a few days to more severe infections that last several weeks and may result in death in the more sensitive subpopulations (for example, young children, elderly, and people with compromised immune systems). Ground water samples from across the United States indicate many samples to be positive for one or more pathogenic viruses using polymerase chain reaction and human viruses were detected in 4.8% of the samples by cell culture.

Concerns over the number of waterborne disease outbreaks that continue to occur in the U.S. despite improvements in drinking water treatment practices, have resulted in the development of regulations to reduce such risks. The Surface Water Treatment Rule (SWTR) and Interim Enhanced SWTR were established in an effort to control microbial contaminants in drinking water systems using surface water or groundwater under direct influence of surface water. In addition, the EPA recently proposed a Ground Water Rule (GWR). The GWR is aimed at addressing microbial contamination of ground water-supplied drinking water systems in accordance with the Safe Drinking Water Act (SDWA) of 1974, as amended in 1986 and again in 1996. The GWR and other regulations address microbial contamination and disinfection by-products (DBP) formation in drinking water systems in order to reduce public health risks resulting from pathogenic contamination and DBP toxicity. The 1986 SDWA amendments directed the EPA to establish national primary drinking water regulations requiring disinfection as treatment for the inactivation of microbiological contaminants for all public water systems, including systems supplied by ground water sources. Worldwide, there is a great interest to redirect investments in water infrastructure to cheap, decentralized, and environmentally sustainable technologies to meet the demand for water and energy in developing countries. The United Nation's Millennium Development Goal is to bring 100 million small farming families out of extreme poverty through low-cost water technologies in the next 10 years. Furthermore, technologies with greater efficiencies than chlorine or iodine to remove microbial agents from water will significantly improve the effectiveness of portable water treatment devices.

Although viruses are only one type of microbial pathogen known to contaminate groundwater, they are much smaller than bacteria and protozoan cysts, and thus are filtered out to a much smaller extent in porous media than bacteria due to their size. Therefore, viruses can travel much longer distances in the subsurface. Viruses are identified as the target organisms in the GWR because they are responsible for approximately 80% of disease outbreaks for which infections agents were identifiable. In addition to viruses, the protozoan parasite Cryptosporidium is another waterborne pathogen of significant public health concern. Survey studies have found oocysts in 4-100% of surface water samples examined, with concentrations up to 10,000 oocysts per 100 L of water. Groundwater may also contain oocysts as shown by a 22% prevalence rate. The difficulty in controlling cryptosporidiosis is due in part to the resistance of Cryptosporidium oocysts to commonly used levels of disinfectants in drinking and recreational waters.

Disinfection is an important water treatment process for preventing the spread of infectious diseases. While mostly effective for removing many bacteria, classical disinfectants, such as chlorine, have been shown as not always being sufficiently effective against viruses and protozoa.

Data collected by the Centers for Disease Control and Prevention (CDC) and the EPA indicate that almost as many waterborne disease outbreaks were reported between 1971 and 1996 in systerns with disinfection treatment that was inadequate or interrupted (134 outbreaks) as were reported in the same period among systems that did not disinfect (163 outbreaks). High doses of chlorine also can produce excessive amounts of disinfection by-products (DBPs) through reaction with DBP precursors such as natural organic matter in source water. More than 500 DBPs have been identified with the most commonly reported, and currently regulated, chlorination DBPs include total trihalomethanes (TTHM: chloroform, bromodichloromethane, dibromochloromethane, and bromoform) and haloacetic acids (HAA5, monochloroacetic, dichloroacetic, trichloroacetic, monobromoacetic and dibromoacetic acids). Many of these DBPs are known or suspected human carcinogens and have been linked to bladder, rectal, and colon cancers (U.S. EPA, 2003a and b). Studies on human epidemiology and animal toxicology have also demonstrated links between chlorination of drinking water and reproductive and developmental effects, such as fetal losses and neural tube and heart defects. It has been estimated that about 254 million Americans are exposed to DBPs, and the U.S. EPA is proposing additional regulations. aimed at protecting public health from DBPs in water. Consequently, it is increasingly recognized that removal of natural organic matter during water treatment is critical for minimizing formation of DBPs in drinking water.

Although strongly oxidizing disinfectants other than chlorine, such as chloramines, ozone, and chlorine dioxide, are being used in the U.S. and Europe, and alternative non-oxidant-based disinfection methods, such as, ultraviolet (UV) irradiation and membrane processes are available, these options are often more expensive in terms of capital investment and operation cost and/or complex and thus difficult to implement. In addition, some of the non-chlorine disinfection alternatives also generate DBPs, which can include bromate.

In addition to drinking water treatment, wastewater discharge and reuse (e.g., through groundwater recharge and irrigation) and land-application of sewage sludge have attracted increasing public attention and growing concern because of the presence of human and animal pathogens in treated wastewater and sludge. Because wastewater treatment generally includes primary and secondary treatment, which may only remove a fraction of the pathogenic microorganisms, discharge of treated wastewater and sludge represent a potential source of microbial contamination. In addition, chlorination and dechlorination (often with sulfur dioxide or sulfite salts) of treated wastewater prior to its discharge not only adds to the treatment cost but also generates undesirable DBPs including THMs, HAAs, and N-nitrosamines that are highly toxic to aquatic organisms.

The Department of Homeland Security has reported that water treatment facilities that use chlorine are more attractive targets for terrorist attack. A major failure of chlorine storage tanks could produce a chlorine gas plume that would affect residents within a ten-mile radius. In addition, accidental release of chlorine gas may have catastrophic consequences. Moreover, some chlorine-manufacturing facilities still use mercury cell electrolysis, a process that can release large quantities of mercury into the environment. If a safer, non-oxidant-based disinfection method is used in a treatment facility to provide additional removal of microbial pathogens, the consumption, transport, and on-site storage of chlorine may be reduced, thus minimizing our dependence on chlorine and the risks associated with the chlorine infrastructure.

One of the most complex problems facing the water industry today is how to provide adequate protection against infectious diseases without the risk from disinfectants and DBPs. It is difficult to manage both microbial and DBP risks, and even more challenging to do so at an acceptable cost. With increasing population and growing demand for potable water, increasingly stringent environmental regulations, and heightened security concerns, developing innovative, inexpensive, and robust technologies that can simultaneously reduce the risks of pathogens, DBPs, and residual disinfectants in drinking water is of utmost urgency.

Portable drinking water systems or chemical additives are available for household use, traveling to remote areas including earthbound and outer space, recreation including camping and hiking, humanitarian purposes, military and engineering operations in remote areas, and disaster relief where water supplies are interrupted. Effective additives for pathogen removal that are currently used in those devices include chlorine, chlorine dioxide, and iodine. However, although chlorine and iodine are effective for removal of bacteria, they are limited in effectiveness against viruses and protozoa (e.g. Cryptosporidium and Giardia).

The present invention addresses above-described problems of biological agents and DBPs in water and provides solutions thereto.

### SUMMARY OF THE INVENTION

This invention is directed to a filtration medium, comprising a base filtration medium that is at least partially-coated with zero-valent metal particles, wherein said zero-valent metal particles are in a size range of from about 1 to about 1,000 nm.

This invention also relates to a process for preparing a NSZV metal-coated filtration medium, comprising the steps of:
(a) providing a base filtration medium;
(b) providing aqueous solution of said metal in an oxidation state greater than zero;
(c) contacting said aqueous solution of said metal in said oxidation state that is greater than zero, with said base filtration medium for a length of time that is sufficient for the required amount of said metal to be retained by said base filtration medium;
(d) optionally, washing said base filtration medium comprising said metal in an oxidation state greater than zero with water;
(e) reducing said metal in an oxidation state greater than zero residing on said base filtration medium to an oxidation state of zero; and
(f) optionally, drying said base filtration medium comprising said NSZV metal coated on its surface.

This invention also relates to a system for removing microbiological impurities from water, wherein said system comprises a conduit or a container comprising a filtration medium comprising a base filtration medium that is at least partially-coated with zero-valent metal particles, wherein said zero-valent metal particles are in a size range of from about 1 to about 1,000 nm.

This invention further relates to a process for removing microbiological impurities from fluids, comprising contacting said fluid with a filtration medium in a conduit or container, wherein said filtration medium comprises a base filtration medium that is at least partially coated with zero-valent metal particles, wherein said zero-valent metal particles are in a size range of from about 1 to about 1,000 nm.

This invention also relates to the final water resulting from the process for removing microbiological impurities from water, comprising contacting said water with a filtration medium in a conduit or container, wherein said filtration medium comprises a base filtration medium that is at least partially coated with zero-valent metal particles, wherein said zero-valent metal particles are in a size range of from about 1 to about 1,000 nm.

### BRIEF DESCRIPTION OF THE DRAWINGS

FIG. 1 shows a schematic diagram illustrating nano-sized zero valent metal particles supported on a granular medium (left) and on a membrane (right).

FIG. 2 shows MS2 removal from water by coated filter media.

FIG. 3 shows T1 removal from water by coated filter media.

FIG. 4 shows fecal coliform and E. coli removal from water by coated filter media.

FIG. 5 shows lead removal from water by coated filter media.

FIG. 6 shows bromodichloroacetic acid removal from water by coated filter media.

FIG. 7 shows chlorine removal from water by coated filter media.

### DETAILED DESCRIPTION OF THE PREFERRED EMBODIMENTS

All percentages expressed herein are by weight of the total weight of the composition unless expressed otherwise.

All ratios expressed herein are on a weight:weight (w/w) basis unless expressed otherwise.

Ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a method”, or “a food” includes a plurality of such “methods”, or “foods.” Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive. The term “comprising” is intended to include embodiments encompassed by the terms “consisting essentially of” and “consisting of: Similarly, the term “consisting essentially of” is intended to include embodiments encompassed by the term “consisting of.”

The methods and compositions and other advances disclosed herein are not limited to particular equipment or processes described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

The following definitions as used in the Specification of the present invention:

The terms “microbial pathogens,” “microbe,” “microorganism,” “microbial agent,” “microbiological agent,” and “biological agent” are interchangeably used throughout the instant disclosure and connote a living organism or non-living biological agent typically too small to be seen with the naked eye; including bacteria, fungi, protozoa, microscopic algae, and biological remnants. It also includes viruses and prions. The term “microbiological impurities” include the microbiological agents, disinfection by-products (DBPs) and disinfection by-product precursors (DBP precursors).

By “removing” microbiological impurities such as microbiological agents is meant that such microbiological impurities such as microbiological agents are removed from the water that has been treated by NSZV (nano-sized, zero-valent) metal-coated filtration medium, their reactivity to NSZV metal has been reduced as a result of the treatment of water by the NSZV metal-coated filtration media, or they have been inactivated as a result of the treatment of water by the NSZV metal-coated filtration media.

The terms “microbiological impurities removing agent,” “microorganism-removing agent,” “microbial pathogen-removing agent,” “microbe-removing agent,” etc., as used herein, mean any NSZV metal or combination of NSZV metals in any form coated on a filtration media that is capable of forming a metal oxide, hydroxide, and/or oxyhydroxide through corrosion or any other mechanism. It can also mean NSZV metals or a combination of NSZV metals coated on the filtration media that has a metal oxide, metal hydroxide, and/or metal oxyhydroxide formed on its surface.

“Filtration medium” and “filtration media” are used interchangeably, and mean one or more media used for filtration. Whether one term is used or the other, both meanings, that of singular (medium) and plural (media) are implicated.

By coating of the filtration media with NSZV metal is meant that such media are fully- or partially-coated with the NSZV metal particles. A filtration media particle (if the filtration media is in particulate form) can be completely-coated, that is no surface of the particle is exposed. If all filtration media particles are completely-coated, then the filtration media is called “fullycoated” with the NSZV metal.

If filtration media is not fully-coated, it is partially-coated. For example, “partial coating” for a given set of NSZV metal-coated filtration media particles can mean: (1) all filtration medial particles are coated but only partially-coated; or (2) some are partially-coated, and/or some are not coated at all, and/or some are completely-coated.

U.S. Patent Publication No. 20060249465 that relates to the U.S. patent application Ser. No. 11/375,206 is incorporated by reference herein in its entirety.

NSZV metal particles, due to their small size exhibit much higher specific surface area (for example, 20-50 m²/g) and correspondingly higher reactivity than regular zero valent metals. The NSZV metal particles can be in the range of from about 1 nm to about 1,000 nm. In one embodiment, the NSZV metal particle size is about 1 nm, about 2 nm, about 3 nm, about 4 nm, . . . , about 998 nm, about 999 nm, or about 1,000 nm. The NSZV metal particles when deposited on a filtration media (alternatively called the base filtration media) particle can be found as individual particles deposited on the filtration media particle or as clusters (more than one particles found in close proximity) of NSZV metal particles deposited on the filtration media particle. The particle sizes of different NSZV metal particles as deposited on the filtration media can vary in size and shape.

Generally, the base filtration medium is selected from the group consisting of anthracite, sand, gravel, activated carbon, zeolite, clay, diatomaceous earth, garnet, ilmenite, zircon, charcoal, ion exchange resin, silica gel, titania, black carbon, and mixtures thereof.

In this invention, NSZV metal-coated filtration media is used for drinking water treatment. In particular, in one embodiment, NSZV metal is deposited onto granular activated carbon (GAC) and ion exchange resin for point-of-use (POU) systems/devices. For this application, advantage is taken of: (1) the high surface area and reactivity of NSZV metal (and thus small NSZV metal mass is needed), and (2) the ability of NSZV metal to remove disinfectants (e.g., chlorine) and to remove/inactivate viruses and bacteria in water (microbiological impurities).

Generally, in one embodiment of the process of the invention, a small percentage of the surfaces of GAC and resin is coated with NSZV metal. This adds new (e.g., virus and bacteria removal) capabilities to these media without affecting their original functions as GAC and ion exchange resin. This is accomplished by replacing GAC and/or resin in a POU filter with NSZV metal-coated GAC or resin.

The instant invention also relates to two synthesis (NSZV metal-coating) methods: (1) Room-temperature chemical method; and (2) High-temperature reduction method or the thermal reduction method. For example, for GAC both approaches can be used, whereas for ion-exchange resins the room-temperature method is preferred. SEM images and XRD data demonstrate that successful coating of NSZV metal onto both GAC and resin.

In one embodiment, for example, with the NSZV metal as iron (NSZVI), iron mass balance and chlorine test results show that the NSZVI content can be varied from about 0.2% to about 35% by weight. While GAC and ion-exchange resin are used for exemplary purposes, the NSZV metal-coating can be accomplished on other filtration media identified previously.

In one embodiment, the GAC prepared using the thermal reduction method provides a superior performance in terms of the removal of microbial agents (viruses and bacteria), chlorine, and other microbiological impurities. The thermal method is the preferred method for the present invention.

NSZVI has a higher surface area (10-100 x) and reactivity than regular (mm-size) ZVI (zero-valent iron). Thus, only a small weight percent of NSZVI is needed to provide significant contaminant removal. The small NSZVI mass used also alleviates the potential concerns of iron getting into filtered water and increased filter weight and transportation cost.

Many POU systems contain particles such as GAC, ion exchange resin, or both, as part of the filter media for contaminant removal from drinking water. However, most granular filter media are not very effective at removing microbiological impurities, especially viruses because of their small size. This invention adds a critical capability to common POU devices. In addition, the NSZV metal media have a greater chlorine removal capacity and the ability to eliminate other contaminants, such as chromium.

Of the different classes of contaminants (organic, metallic, biological, radioactive, etc.), removal of biological contaminants are of the highest importance with respect to drinking water. These contaminants are not effectively removed by filtration media, such as GAC and ion exchange resin, that are commonly used in granular POU water systems. With growing population and increasing impact of human activities on our limited water resources, more “pollutant barriers” will need to be put in place to ensure drinking water quality and protect consumer health. Effective, small-scale, and disposable/portable POU devices that require little or no energy/pressure to operate are a necessity. Granular filter media provides additional protection against microbial agents and other contaminants and are easy to adopt (by simple substitution) and are commercially viable and have a growing worldwide market.

NSZVI of the instant invention can remove As (especially As^{V}), Cr^{VI}, U^{VI}, other metals, and many organic chemicals including haloacetic acids and other DBPs.

POU filters containing the NSZVI media have superior performance overall, and are cost-effective and commercially feasible. Some of the uses of the POU containing the NSZVI media include household disposable water filters, portable water filters for camping, hiking, and other outdoor activities, POU devices for transportation (ground, sea, or air travel), and other stationary or mobile POU systems.

The invention is broadly related to treating a fluid medium by a filtration medium. The fluid medium to be treated can include, but is not limited to, a liquid medium. More specifically, the invention relates to treating water. In one aspect, the fluid is exposed to filtration medium that include NSZV metal that has been coated on the filtration medium.

Gas medium can also be treated with the NSZV metal-coated filtration media.

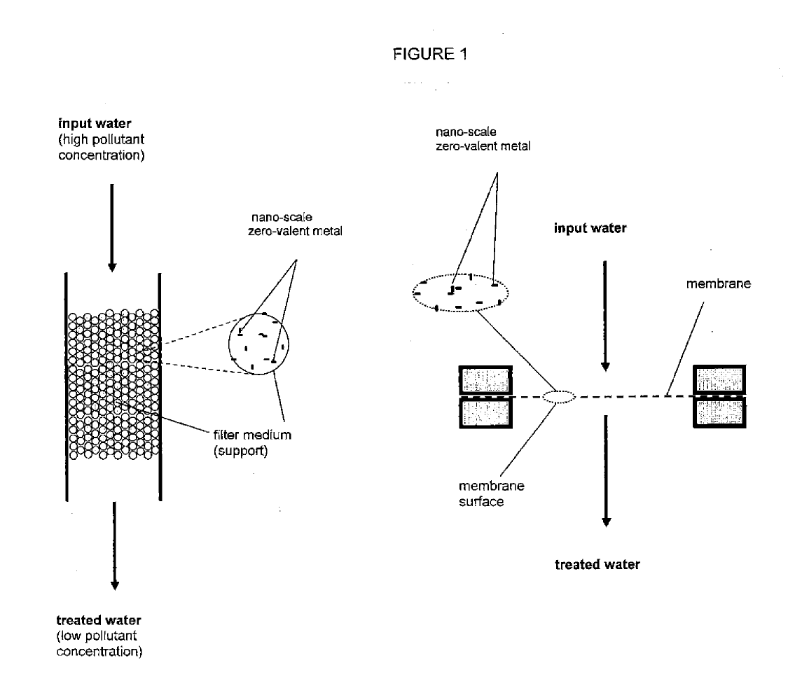

FIG. 1 shows on the left a schematic of polluted water entering a column containing NSZV metal-coated granular media and exiting the column as treated water. NSZV metal particles coated onto the granular media are illustrated. The right side of FIG. 1 shows polluted water being passed through a membrane coated with NSZV metal-coated particles and exiting as treated water. NSZV metal particles coated onto the membrane are illustrated In one aspect, the invention comprises a filtration medium that is fully or partially-coated with NSZV metal.

In one aspect, the invention relates to removing microbial pathogens from water by treating the water with filtration medium that is coated with NSZV metal. In another aspect, the invention relates to a device comprising such filtration medium for treating water.

In a particular aspect, the invention comprises a process for removing the microbial pathogens from fluid medium sought to be treated, comprising, coating a filtration medium with ionic metal that is capable of oxide, hydroxide, and/or oxyhydroxide through corrosion, reducing the ionic metal to its ground state, mixing the coated filtration medium with the uncoated filtration medium, and exposing the fluid medium with such filtration medium. In a particular aspect, the process occurs in a conduit or container. This encompasses both a “flow-through” conduit or a container (for example, in one embodiment, a packed column or a filter) or a “batch” conduit or a container. An example of “batch” conduit or a container, which is described infra, includes for example, a pouch or a bag that includes NSZVI-GAC filtration media, or the NSZVI-CER filtration media.

The process can be a water purification process. In one aspect, the process is carried out in a water treatment plant or a portable unit. The water treatment plant can be a stationary unit. In the disclosure below, water has been used only as an example of fluid medium to be treated. The invention, however, applies equivalently to other fluids.

This invention relates to using elemental metal to remove microbial pathogens from water because elemental metal can continuously generate and renew the surface oxides, hydroxides, and/or oxyhydroxides through corrosion or any other mechanism in water, and that such metal oxides, hydroxides, and/or oxyhydroxides remove microbial pathogens from water.

### NSZV Metal-coated Filtration Medium

In one aspect, this invention relates to filtration medium that is coated with NSZV metal. Zero-valent elemental metal means that the elemental metal substantially has a valence of zero, for example, a zero-valent iron would be designated as Fe^{o}. The base filtration medium (uncoated) is a filtration medium that is generally used for filtration of water. In one aspect, the filtration medium is granular, consisting of particulate matter from about several microns to several millimeters. In the present invention, such filtration medium particles are coated with NSZV metal.

In one aspect of the invention, if the filtration medium is a particulate filtration medium, the number of filtration medium particles coated with the NSZV metal, from a set of given number of filtration medium particles is in the range of from about 0.5% to about 35.0%. In another range for this invention, the number of particles coated is in the range of from about 1.0% to about 35.0%. Similarly, the lower limit of such ranges, or the upper limit of such ranges, include numerical percentage values selected from the following numbers:

1.0%, 1.5%, 2.0%, 2.5%, 3.0%, 3.5%, . . . 33.0%, 33.5%, 34.0%, and 34.5%.

In this aspect of the invention, the percentage of the total available coatable filtration medium surface area that is coated with the NSZV metal is in the range of from about 0.25% to about 35%. It is possible that a given particle may be partially coated or fully coated. However, in this aspect of the invention, whether a given particle is partially coated or fully coated, the overall percentage of the filtration medium coated, as measured by its BET surface area is from about 0.25% to about 35%. In another range for this invention, the percent coating is from about 0.5% to about 35% of the total available coatable surface area of the filtration medium particles. Similarly, the lower limit of such ranges, or the upper limit of such ranges, include numerical percentage values selected from the following numbers:

0.5%, 0.75%, 1.00%, . . . , 34.00%, 34.25%, 34.50%, and 34.75%.

In another aspect of the invention, the weight percent of the NSZV metal as coated on the filtration medium is in the range of from about 0.2% to about 35%. The density of any elemental metal will generally be higher than the uncoated filtration medium. In another range for this aspect of the invention, the weight percent of the NSZV metal as coated on the filtration medium is in the range of from about 0.2% to about 35%. Similarly, the lower limit of such ranges, or the upper limit of such ranges, include numerical percentage values selected from the following numbers:

0.3%, 0.4%, 0.5%, . . . , 34.0%, 34.4%, 34.6%, and 34.8%.

In one embodiment, the NSZV metal is coated at discrete locations on the surface of the filtration media particles. Stated another way, in this embodiment, the NSZV metal-coated on the filtration media and the uncoated filtration media can treat the water simultaneously.

The uncoated filtration medium or the basic filtration medium can be one or more of the filtration medium known to a person skilled in the art. More than one type of filtration media can be blended in a “salt-and-pepper” configuration. If there are more than one filtration media, in the present aspect of the invention, at least one of the filtration medium is coated with the NSZV metal. Within each type of filtration medium, if coated, the above range limitations apply. The above range limitations also apply to the overall filtration medium.

In one embodiment, the NSZV metal-coated filtration media particles can be found in a singular layer at the top and/or the bottom of the filtration media.

In another embodiment, the NSZV metal-coated filtration media particles may or may not be in a singular layer at the top and/or at the bottom. However, in this embodiment, within the body of the filtration media, there is at least one layer that is the NSZV metal-coated filtration media particles. These intermediate layers (or the single layer at the top and/or the bottom) may or may not be a salt and pepper blend with non-coated, same or different, filtration media, or NSZV metal-coated different filtration media.

In yet another embodiment, the first NSZV metal-coated filtration media is mixed with one or more, second NSZV metal-coated filtration media in a singular layer at the top and/or the bottom, and/or in the intermediate layers.

Preferred uncoated filtration medium includes particles selected from anthracite, sand, gravel, activated carbon, zeolite, clay, diatomaceous earth, garnet, ilmenite, zircon, charcoal, ion exchange resin, silica gel, titania, black carbon, and mixtures thereof. Preferred are granulated activated carbon and cationic exchange resins. Other uncoated filtration medium include all types of membrane filters, paper filters, sponges, nets, and fibers.

In one embodiment, one or more than one type of filtration media are coated with one or more than one type of NSZV metal. Even with this mixed filtration media and mixed metals, the above ranges apply as a combined metal and combined filtration media weight.

In one embodiment, the invention includes a water or liquid permeable bag that is sealed and enclosed with NSZV coated filtration media. This bag, for example, the size of a tea-bag can be used for effectively treating small amounts of water—in mL volumes. Bags can be devised to treat even large volumes of water—in hundreds of gallons of water. The bags or pouches can vary in size, depending upon the volume of water to be treated. For example the bags could vary from sizes that are smaller than a tea bag to those that are 1 square feet. Of course bigger bags or smaller bags, depending upon necessity can be made.

Clearly, one or more than one bags can be used to treat water and expedite contaminants removal from water. The bag is made of such material that allows for water or liquid to permeate through the bag material, but is sufficiently impervious to the NSZV coated filtration media. It is possible that the bag material may not be 100% impervious to NSZV coated filtration media, but still is substantially impervious to the transport of the NSZV coated filtration media. Bag material can be any material that is pervious to water. For example, paper, non-wovens, cloth, wovens, plastic/metal/cloth nets, plastic/metal/cloth meshes, etc.

In another aspect of the invention, the bag is brought in contact with the water to be treated. Contact time can be from several seconds to several hours, for example, overnight treatment.

### Process of Preparing NSZV Metal-coated Filtration Medium and Water Treatment

In the first step of preparing the NSZV metal-coated filtration medium, the filtration medium is exposed to an ionic solution of the elemental metal. For example, if NSZVI were to be coated on the uncoated filtration medium, such uncoated filtration medium would be exposed to FeCl or FeCl₃ solution. In the next step, the now coated filtration medium is dried in air or nitrogen or another inert gas or gas mixture, or vacuum. Upon drying the coated filtration medium is now reduced using reducing agents known to a person skilled in the pertinent art. For example, reducing agents that can be used include hydrogen, etc. In the next step, depending upon the requirement, the coated filtration medium is mixed with the uncoated filtration medium in the percentage range desired and disclosed in the previous section.

Once the appropriate filtration medium is prepared, that is the coated and the uncoated filtration media are mixed according to the desired ratio, such mixture is packed into a device for filtration. Water to be treated is passed through the filtration device, with the residence time of water determining the length of the device or the flow of the water, and vice versa.

In one embodiment, the NSZV metal-coated filtration media can be used in a batch mode, for example, a one-time or a few-time use of the coated filtration media. For example, people working in remote destinations such as troops, engineers, travelers, hikers, and campers can add a pouch comprising the NSZV coated filtration media to a local natural water, shake it up in a contamer such as a cup to treat the water for removing microbiological pathogens and other impurities.

Optionally, water may be back-pulsed through the filtration medium device to clean the filtration medium or expose fresh surface. Optionally, the filtration medium can be treated with a reducing agent to expose fresh NSZV surface. To control or optimize the residence time of the liquid, usually water, a salt and pepper type mix can be used or layering, regions, or other configurations, circular, concentric, annular, etc., multiple filtration medium coated/uncoated, circular concentric can be used.

In accordance with the present invention, even a very thin layer of NSZVI (used as the microorganism—removing agent) in the flow path of virus—(or other) contaminated water can achieve a 5 to 6-log (or even more) removal of the microbiological pathogens. Clearly, elements, such as iron, are capable of removing and/or inactivating microorganisms, such as viruses.

Both MS2 and T1, which are both bacteriophages or bacterial viruses that have a structural resemblance to many human enteric viruses, and fecal coliform and pure culture E. coli can be significantly removed from solution after pumping water containing them through a filtration column containing NSZVI. The more NSZVI that is used, the more viruses are removed. Removal efficiencies for viruses can be about 3-log₁₀ (99.9%), about 4-log₁₀ (99.99%), about 5-log₁₀ (99.999%), about 6-log₁₀ (99.9999%) or even higher. In addition to the amount of iron, flow velocity may also affect the removal efficiency in some cases. Namely, a slower flow velocity can result in a higher removal efficiency. Mass balance results suggest that the removal of viruses is primarily due to inactivation or irreversible sorption, however this invention is not limited any theories for removal.

In accordance with the present invention, NSZVI can be employed for the treatment of microbially-contaminated aqueous media, including drinking water, wastewater, groundwater, backwash water, irrigation water, ballast water, food-processing water, leachate, and other aqueous wastes such as medical wastes, and gaseous media including pathogen-laden air streams and process off-gases. In addition, processes of the present invention are also potentially useful for removal of prions, which may cause, for example, mad cow disease. Prions are nanometer-size protein particles that are biological in nature. Since elemental iron (through corrosion and oxide/oxyhydroxide formation) can remove viruses, which consist of a protein sheath, iron is expected to also be effective in removing prions. In addition, processes of the present invention are also useful for the removal of DBP precursors such as natural organic matter including humic acid and fulvic acid, as these DBP precursors are known to adsorb to metal oxides and thus can be removed with elemental iron or other metals.

Elemental iron corrodes in water; that is, it is oxidized by dissolved oxygen, other oxidants in water, and water itself. Any element or combination of elements that corrodes in water may be useful in some embodiments of the present invention.

Iron corrosion generates minerals, such as iron oxides, hydroxides, and oxyhydroxides (e.g., goethite and magnetite) on the surface, and iron oxides, hydroxides, and oxyhydroxides are capable of removing microorganisms from water. The mechanisms of removal may involve adsorption of microbial particles (e.g., viruses and bacteria) in water to iron surfaces through electrostatic attraction and/or other interactions. Aluminum functions in the same way by forming an aluminum oxide and hydroxides on the surface, and these aluminum corrosion products remove microorganisms from water. Iron and aluminum oxides and oxyhydroxides contain abundant positively charged surface sites because these minerals typically have a zero point of charge (pH_{zPc}) at circum-neutral or alkaline pH, whereas most bacteria and viruses are negatively charged at neutral pH and therefore are attracted to the metal surface. Since iron corrodes to form new surface sites continuously in water and other aqueous media, iron is useful for removing viruses for as long as the corrosion of the iron continues that can be for multiple years. Iron may be preferable in some cases although use of aluminum and other corrodible metals is also possible. When water containing microbes (such as, viruses and bacteria) and DBP precursors (such as, humic acid) comes into contact with elemental iron or aluminum particles (for example, in a treatment column or filter media), corrosion products of iron or aluminum will be generated constantly and microbes and DBP precursors can be removed from water in a continuous fashion.

As used herein, iron and/or aluminum are referred to specifically.

The present invention is useful, for example, in water treatment plants producing drinking water. Water can be treated in a treatment column, cartridge, or filter containing elemental iron (in the form of filings, shavings, or granules of pure, cast, gray, or scrap iron, for example) as an active component to remove microorganisms and/or DBP precursors in the water. Alternatively, iron or aluminum particles (and/or other corrodible metals) may be applied to treat water in a reactor, such as a mixed tank reactor or a batch reactor, to remove microbes, DBP precursors, and other undesirable materials from the water. Similar applications for the removal of microorganisms and/or DBP precursors from other aqueous (such as, wastewater and groundwater) and gaseous media (such as, air and off gases) are also envisioned. The present invention provides substantial benefits over other standard treatment options as it provides an effective, inexpensive, simple, and flexible method for removing virtually any type of microorganisms. In addition, through oxide and hydroxide formation, iron and aluminum can remove natural organic matter such as humic and fulvic acids from water and thus minimize the levels of toxic DBPs in drinking water. Within the scope of water treatment plants as used herein are municipal or regional water treatment facilities, a disposable tap water filter that has a service life of, for example, a few weeks; a part of a semi-permanent water purification/softening system for the entire home, that requires media replacement, for example, once a year; and an additional purification step for well water, as can be used, for example, in rural areas.

The system of the invention can be portable. Such a portable water treatment system is useful in households, in traveling, for camping or hiking, during natural disasters, and in developing countries where basic water treatment practices do not exist. Current practice is to use iodine or microfiltration in such settings. Iodine is not very effective at removing viruses and protozoa. Moreover, microfiltration is ineffective in removing viruses. A portable water treatment system can be any suitable size. In particular, it can be hand-held. A portable water treatment system can also be mounted on a vehicle, railroad car, or ship.

Incorporation of substantially NSZVI (and/or substantially zero-valent aluminum or other similar material) into new or existing filtration media and/or tank reactors can be used, for example, as follows: a) as a pre-disinfection process before chlorination or other disinfection treatment, to eliminate the need for storing liquid chlorine in water and wastewater treatment plants and other facilities, which can raise risks of accidental or deliberate release of chlorine (e.g., due to terrorist attack); b) to reduce the dosage and/or contact time of disinfectant (s) required to achieve desired removal of microorganisms and prevent re-growth during distribution, thus minimizing pathogens, DBP formation, and residual disinfectant levels in water simultaneously; c) to circumvent and/or prevent potential terrorist activities as zero-valent iron and other similar materials may be effective against many toxic chemicals and biological agents released to air or water by terrorists; d) to help to reduce or possibly completely eliminate chlorine use in water which would be useful to government agencies and utility companies seeking to meet drinking water standards.

Elemental iron can be found in anything containing iron metal, including but not limited to steel (or its derivatives, like nuggets, shots, grit, etc.), scrap iron, cast iron, iron sponge, powder, filings, and slugs. Aluminum containing material of any type, shape and form can also be used if desired for any reason. Elemental iron is in some cases preferred over Fe²⁺ and Fe³⁺ compounds because its capacity to remove microbes and DBP precursors is renewed continuously through corrosion and thus it will last much longer without having to be replaced or rejuvenated as often.

Similarly, for wastewater treatment, an active or passive treatment system involving elemental iron or aluminum may be used to remove viruses, bacteria, protozoa, other microbes, and/or DBP precursors from wastewater to meet the treatment or discharge requirement and to minimize the negative impact of wastewater discharge to the ecosystem. For groundwater applications, passive underground iron PRBs or active injection of iron particles or suspensions into the subsurface, for example, are two possible approaches to remove microorganisms, such as viruses, from groundwater and/or to prevent their migration in the subsurface. In these examples, such treatment (or pre-treatment) with elemental iron or aluminum may save the cost of disinfection (e.g., through use of less disinfectants and other chemicals) and at the same time reduce the formation of harmful DBPs associated with use of chlorine, ozone, or other disinfectants.

The present invention has several significant benefits. For example, existing granular media (e.g., activated carbon and ion exchange resins) widely used in many small-scale and portable water filters are not effective/able to remove microbial contaminants, particularly viruses. This invention discloses a NSZVI coated filtration media and methods to coat NSZVI to the media adding this new capacity/function to these media, in a manner that is suitable for drinking water applications, without affecting the original intended purposes of these media (i.e., to remove organic and inorganic chemical contaminants from water). The other benefits of this invention include removal of chlorine, DBPs and some other chemical pollutants. Thus the present invention serves the benefits of improving protection of public health from water-borne diseases and other pathogens and/or DBPs. Also, corrosion of iron and aluminum does not create any toxic by-products and therefore pose little threat to the environment and human health. In fact, when used for drinking water treatment, iron and aluminum corrosion products, such as Fe₂²⁺, Fe₃³⁺, and Al₃³⁺ ions, can serve as coagulants to improve the efficiency of water treatment (i.e., better removal of suspended solids from water) and reduce the chemical cost for coagulants, such as ferrous sulfate, ferric chloride, and aluminum sulfate.

Depending on the amount of iron/aluminum used and the contact time, the treatment alone may achieve sufficient disinfection. Alternatively, the novel process may be combined with a subsequent and/or prior disinfection method, such as UV irradiation, chlorination, ozonation, or chloramination to meet the desired treatment goal. In the latter case, an iron/aluminum pretreatment can lower the material and operational costs for disinfection and can also minimize the safety concerns associated with using chemical disinfectants.

By removing natural organic matter, well-known precursors of DBPs, and lowering the dosage of disinfectants used, the proposed iron/aluminum treatment also has an added advantage of reducing the potential of DBP formation and the toxicity of residual disinfectants. DBPs are toxic and/or carcinogenic compounds formed through reactions of DBP precursors (e.g., natural organic matter) and chemical disinfectants used in water and wastewater treatment processes (such as chlorine).

Elemental iron and/or other elements alone or in combination are employed to remove and/or inactivate microorganisms from water or other media. The two viruses and the cast iron employed are merely exemplary Similar results would also be achieved with other types of elemental iron and aluminum. In addition, a combination of iron and aluminum and/or other elements could be used. In some embodiments, the present invention relates to a conduit such as a column filled with standard water filtration media (e.g., anthracite, sand, gravel, activated carbon, zeolite, clay, diatomaceous earth, garnet, ilmenite, zircon, charcoal, and/or ion exchange resin). Alternatively, the present invention could take any other desired form such as a continuous-flow, batch, or semi-batch mixed—tank reactor containing water to be treated, to which iron or aluminum is added to remove microorganisms and/or DBP precursors.

This invention preferably employs a device which utilizes a medium that contains elemental iron or aluminum as an active component in a batch, semi-batch, or flow-through column or tank system for the treatment of drinking water, wastewater, surface water, groundwater, backwash water, leachate, or any other liquid or gaseous streams containing microbial agents and/or DBP precursors. The device, which may be either portable or stationary, may comprise a column, conduit, cartridge, filter, barrier, tank, or another device or process (termed “device” hereafter) which utilizes a microorganism-removing agent. The device contains any microorganism-removing agent such as elemental iron or aluminum as an active treatment component and may also contain other constituents, such as sand or gravel, for functional, economic, or any other desired purposes (e.g., to minimize head loss, to prevent clogging, or to control pH). Water or air (or other material sought to be treated) is introduced into the device containing the microorganism-removing agent, such as elemental iron or aluminum. After a sufficient contact time, which depends on factors such as system configuration, amount of microorganism-removing agent, mixing, and flow rate, microorganisms and/or DBP precursors are removed from the influent water or air by iron and/or aluminum particles. The treated water or air exiting the device (i.e., the effluent) will have a lower content of microorganisms and/or DBP precursors than the influent water. The viral content can be reduced by 50%. In a particular case, the viral content in water can be reduced using iron by about 97% to about 99% and even 99.999% or more in some cases. In the present invention, any flow velocity can be employed. The flow velocity when a column is employed is preferably from about 0.1 cm/h to about 10 m/min, particularly preferably at least about 1.0 cm/h. Any desired residence time can be employed. In some embodiments, a residence time in the corrodible material is preferably at least about 0.1 second, particularly preferably from 1 second to 500 minutes, and even more preferably from 5 seconds to 60 minutes. In one aspect, the residence time is from about 2 minutes to about 30 minutes. The residence time can be about 5 minutes to about 20 minutes. In a particular aspect, the residence time is about 20 minutes. In another particular aspect, the residence time is about 8 minutes.

Column or batch experiments can be conducted using two viruses, to prove the concept and to demonstrate the effectiveness of elemental iron in removing microorganisms from water. For the column experiment, flitted stainless steel plates are placed at both ends of the columns to obtain a uniform flow distribution. A fraction collector can be used to collect samples. All columns are packed wet to avoid trapping of gas bubbles. The solution is deoxygenated by nitrogen and degassed under vacuum to remove dissolved oxygen and other gases. Column performance and hydrodynamic properties can be determined with bromide as a conservative tracer (this can be quantified by a Dionex ion chromatograph). The column experiments are conducted in a room with temperature controlled at 4-6° C. to avoid virus inactivation at high temperatures.

This invention can potentially be used to treat any liquid or gaseous media, and in particular, is adapted for use with drinking water, wastewater, surface water, backwash water, irrigation water, food processing water, ballast water, leachate, groundwater, other aqueous wastes, contaminated air, and off gases.

Existing water disinfection methods involve use of strong oxidizing chemicals, such as chlorine (or hypochlorite), bromine, iodine, chloramines, chlorine dioxide, and ozone to kill microorganisms in water. Chlorine is the most commonly used disinfectant in the U.S. and many other countries, but it has been shown to be less effective for viruses and protozoa than for bacteria. These disinfectants, all of which are toxic chemicals and have many safety concerns, need to be stored or generated on-site and applied on a continuous basis. In addition, the process requires active control and laborious maintenance. Furthermore, other chemicals (e.g., hydrochloric acid, sodium hydroxide, sulfur dioxide, etc.) are needed to control the pH and/or neutralize excess disinfectants. Some disinfection methods, such as ozone and UV disinfection, are less flexible, more complex and difficult to operate, and require large initial capital investment. Finally, many of these chemical disinfectants can react with constituents, such as natural organic matter, in water and wastewater to produce significant levels of toxic or carcinogenic DBPs including trihalomethanes, haloacetic acids, and bromate.

In contrast, the invention differs from existing water and wastewater disinfection processes in that (1) it can be passive and requires little maintenance, (2) it does not involve use of hazardous chemicals, (3) it does not generate harmful (by) products, (4) it is less expensive than the existing chemical (oxidative) methods to disinfect water, UV-, ozone-, and membrane-based POU systems for removing microorganisms from drinking water, and (5) it is flexible and involves low capital investment, and can be used as a stand-alone unit or added/retrofitted to existing treatment facilities.

The following examples illustrate the invention. All parts and percentages are on a weight basis unless otherwise indicated.

### EXPERIMENTAL

### Example 1

Filter media were prepared by incorporating NSZVI into two filter media, granular activated carbon (GAC) and cation exchange resin (CER), for drinking water applications. These NSZVI enhanced media were characterized. The NSZVI based media demonstrated their superior performance with respect to the removal of microbial agents, chemical contaminants, and disinfectant from drinking water.

While iron was used as an exemplary metal, other metals such as aluminum can also be used. Two reduction methods were used to form the filter media, high temperature (dry) reduction and aqueous chemical (wet) reduction, for coating NSZVI onto GAC and CER. Both methods involve deposition of ferric ion, Fe(III), onto a medium surface followed by dry (with hydrogen) or wet reduction (with sodium borohydride) of Fe(III) to NSZVI. Coating of GAC using both methods was used, whereas coating of CER by wet reduction only was used because CER is labile at high temperatures (max. temp.=121° C.). We note that while hydrogen and sodium borohydride are used for reduction, other appropriate reducing agents may also be used.

Each of the NSZVI fortified filter media that were formed where characterized for total Fe quantification, X-ray diffraction (XRD), scanning electron microscopy (SEM), energy dispersive X-ray spectroscopy (EDX), and Brunauer-Emmett-Teller (BET) surface area analysis. These tests confirmed the successful deposition of NSZVI and its content determined, and the morphology, compositions, and distribution of NSZVI particles on GAC and CER.

The following materials, apparatus, and procedures were used to prepare NSZVI coated GAC and CER.

The support filter media used was TOG GAC (20×50 mesh) from Calgon Carbon Corporation (Pittsburg, Pa.) and Amberlite® IR-120 cation exchange resin (sodium form, 16×45 mesh) from Sigma Aldrich (St. Louis, Mo.). Ferric nitrate nonahydrate (Fe(NO₃)₃. 9H₂O, Across Organics, Morris Plains, N.J.) or ferric chloride (anhydrous FeCl₃, Fisher, Pittsburgh, Pa.) was used as a source of Fe(III). Hydrogen and nitrogen were from Keen Compressed Gas (Wilmington, Del.) and sodium bromohydride (NaBH₄) was from Sigma-Aldrich. All solutions were prepared using deionized (DI) water (>18 MΩ).

The coating of GAC involved dissolution of a target mass of ferric nitrate nonahydrate in 50 mL of DI water in a 250-mL Pyrex flask using a homogenizer motor drive (Glas-Col) with a Teflon® coated stir shaft under ambient conditions. Upon complete dissolution, a measured mass of GAC was added. The amounts of ferric salt and GAC were determined based on the desired iron loading. The ferric-GAC mixture was stirred continuously and all the iron was transferred onto GAC upon further mixing/processing. The flask and content were then removed from the homogenizer and placed in a 100° C. oven for drying.

For the coating of CER, a measured amount of ferric chloride was mixed with approximately 5 (wet) g of CER in a clear glass bottle containing DI water. The iron mass was varied as needed to obtain the desired target Fe-to-CER ratio. The bottle was placed on an orbital shaker at 200 rpm and samples were taken at different times for iron analysis using FerroVer® reagent and a Hach DR5000 spectrophotometer (Loveland, Colo.). Upon complete transfer of Fe(III), CER was removed and washed with copious DI water prior to reduction.

Reduction of Fe³⁺ on GAC to NSZVI was carried out at high temperatures (<800° C.) under a hydrogen atmosphere. A stainless steel reactor (capacity=78 cm³) was used to carry out the reduction and was fabricated and configured to fit inside a modified box furnace (Thermolyne Type 1300). A network of ⅛ inch stainless steel tubing (McMaster-Carr, Type 316) complete with two glass ball flow meters (Key Instruments) and three-way ball valve (Swagelok) was constructed as a gas delivery system in order to regulate gas flow and monitor flow rate through the reactor. A measured mass of Fe³⁺-coated GAC was placed in the reactor and the cover placed over the top. To protect the physical integrity of the reactor and extend its service life, a light coat of high-temperature food-grade anti-sieve thread compound (Tri-Flow) was applied to the threads of the socket cap screws used to seal the reactor. The sealed reactor was then connected to the compressed gas delivery line that entered the box furnace through one of three rear bore holes. An exhaust line fed through another rear bore hole was connected to the reactor outlet and served to carry away spent gas and byproducts (vented to a fume hood). After the reactor was securely connected, a target temperature was set and the box furnace turned on. Reactor temperature was monitored using a digital thermometer (Omega, model CN1001TC) fed through a rear bore hole in the furnace. The heating time was varied as appropriate depending on the target temperature.

After reduction, the product was cooled under nitrogen to minimize NSZVI oxidation. Each batch process produced approximately 35 g of NSZVI coated GAC. During product retrieval from the reactor, NSZVI coated GAC exhibited a pyrophoric effect upon exposure to oxygen. The pyrophoric reaction indicates successful reduction of Fe(III) to NSZVI; this rapid oxidation is undesirable as it consumes a portion of the NSZVI forming an oxide shell of a few nm in thickness on NSZVI particles.

Reduction of Fe(III) on CER was carried out in an anaerobic glove box (Coy Laboratory, Mich.) under an N₂/H₂ (90/10) atmosphere. Because CER was heat-labile, reduction was carried out at ambient temperature using NaBH₄ as a reducing agent. Fe³⁺-coated CER was immersed in deoxygenated DI water in a 500-mL flask. Deoxygenation was accomplished by purging DI water with N₂ (final dissolved oxygen concentration was below 0.1 ppm). NaBH₄ solution (0.05 M) was introduced drop-wise into the flask while the flask was continuously shaken at 80 rpm. Addition of NaBH₄ continued until solution pH did not change further. After reduction, NSZVI-coated CER was washed with DI water several times. The washed product was sealed, removed from the glove box, and dried in a vacuum oven pre-purged with N₂. Dried NSZVI-coated CER was kept in the glove box in a glass bottle containing drierite to prevent oxidation of NSZVI by air and moisture.

Characterization of the NSZVI coated GAC and CER by Fe analysis, BET, XRD, SEM, and EDX was done and the results are summarized below.

### Fe Analysis for NSZVI Quantification

Fe analysis was performed on GAC and CER samples in order to determine the total iron loading on the media and iron transfer/coating efficiency. This was accomplished through nitric acid extraction followed by iron quantification. Results for a GAC sample with a target NSZVI loading of 3%, are described below as an example.

First, a standard iron solution was prepared by dissolving 0.4327 g of ferric nitrate nonahydrate in 100 mL of DI water, resulting in a 10.7 mM ferric nitrate solution with an iron concentration of 600 mg/L. Next, 2 g of NSZVI GAC was added to 10 mL of nitric acid (Fisher, ACS Plus) and mixed in a 50-mL volumetric flask using a Teflon® coated stir bar for 20 min. After mixing, the solution was transferred to a 250-mL flask containing 80 mL of DI water. An additional 10 mL of nitric acid was added to the acid-washed NSZVI-GAC and the procedure repeated. The 100 mL of solution containing acid rinsates and the standard iron solution were analyzed and compared.

Total iron measurements were carried out on 5-mL samples using the FerroVer reagent (Hach, Permachem Reagents) and a UV-Vis spectrophotometer (Hach, DR 5000). Dilutions were made to all samples tested and duplicates of each sample were also measured to confirm the results.

TABLE 1
Iron concentrations of 3% NSZVI GAC extract and a standard solution
measured using a spectrophotometer (Nos. 1 & 2 are duplicate samples).

| Sample | Dilution | Absorbance |
|---|---|---|
| Standard #1 | 10⁴ | 0.127 |
| NSZVI-GAC #1 | 10⁴ | 0.126 |
| Standard #2 | 10⁴ | 0.129 |
| NSZVI-GAC #2 | 10⁴ | 0.128 |

As shown in above Table 1, the close agreement between the acid extract and standard indicates the NSZVI-GAC synthesis procedures described above could generate NSZVI-GAC with a 3% target iron loading. The result illustrates that control the NSZVI loading was controlled and that the transfer of Fe³⁺ onto GAC was efficient and complete and little Fe³⁺ was wasted in the synthesis.

### BET Surface Area of GAC and NSZVI Coated GAC

BET surface area analysis was conducted for GAC and NSZVI coated GAC to evaluate the extent of loss in GAC pore area (and hence sorption capacity) due to iron addition. This is an important concern for GAC because of the large amount of micropores it contains which contribute to its high sorption capacity. The analysis was performed with N₂ using a Quantachrome NOVA 2000 high speed gas analyzer. Approximately 0.1 g each of GAC and ˜3% NSZVI coated GAC were vacuum degassed at 150° C. overnight prior to analysis. Using a five-point calibration, the NSZVI coated GAC had a specific surface area of 792 m²/g, compared to 798 m²/g for the original GAC. The negligible decrease in surface area indicates that addition of NSZVI at 3% to GAC resulted in an insignificant loss of GAC surface area. The NSZVI coating, while providing new/enhanced capacities for contaminant removal results in little loss in the sorption capacity of GAC.

### XRD Analysis of NSZVI Coated GAC

To confirm the elemental state of iron on synthesized NSZVI GAC, X-ray diffraction (XRD) was performed on a Rigaku X-ray Diffractometer (Ultima IV), using Cu Kα radiation (λ=1.54059) at 40 kV and a sampling width of 0.02 degree at a scan speed of 1.0 deg./min. XRD patterns for NSZVI GAC samples prepared for two different iron loadings (3% and 15%) over a scan range of 20-90°. Three peaks characteristic of elemental iron were identified. These XRD results confirm the presence of NSZVI on the surface of GAC and that the NSZVI GAC synthesis procedure successfully reduced ferric iron to its zero valent state. In addition to the three zero valent iron intensity peaks identified on the pattern plots, several peaks are also visible in the scan range of 20-400. These peaks are attributed to the GAC. The most visible is the carbon allotrope graphite whose intensity is highest at 26.6°. In addition to the background peaks from GAC, at around 35° a minor peak is visible that represents an iron oxide, possibly wiistite (FeO) or magnetite (Fe₃O₄), which formed due to incomplete reduction or post-synthesis passivation of NSZVI.

### SEM and EDX Analyses of NSZVI Coated CER and GAC

A scanning electron microscope (SEM, S4700, Hitachi High Technologies America, Inc.) was used to obtain the surface morphology of the original CER and NSZVI coated CER. In addition, energy-dispersive X-ray analysis (EDX) was performed to confirm the presence of iron on CER surface. The CER consisted of spherical particles of diameter 0.3-0.5 mm and shows the relatively smooth surface of CER, which would facilitate the identification of coated NSZVI particles. The surface morphology of NSZVI coated CER, where spherical particles of 20-30 nm, and aggregates of these particles as large as 100 nm or more were present. These nano-particles and aggregates are clearly absent on the original CER and are the NSZVI particles formed through reduction of coated Fe(III). The nano-particles are relatively evenly distributed throughout the CER surface and collectively cover about 15% of the surface examined.

SEM was also performed on GAC and NSZVI coated GAC and images were obtained. The complex, non-uniform nature of GAC surface morphology did not allow for the discernment of NSZVI.

EDX analysis of CER and NSZVI-CER was also performed where X-rays were detected from the sample excited by a focused, high-energy primary electron beam penetrating into the sample. EDX spectra for CER showed an elemental composition of mainly carbon, oxygen, and sulfur, consistent with the styrene-divinyl-benzene matrix and sulfonate functional group of this CER. There were four additional peaks for NSZVI CER, three corresponding to iron and one to sodium. The procedure had deposited iron onto CER, which is consistent with the SEM result. The sodium was possibly derived from the reductant, NaBH₄, and was incorporated during reduction.

Based on the above results, the following conclusions can be drawn.

The coating and reduction methods can successfully add NSZVI particles onto GAC and CER. The high-temperature hydrogen reduction method is more suitable for coating NSZVI on GAC, whereas the wet reduction method may be more appropriate for coating NSZVI on CER.

These procedures controlled the NSZVI loading desired. While only data for certain percentage are shown (e.g., 3% and 15% NSZVI on GAC), media having lower and higher NSZVI loadings have been made successfully. In addition, the iron transfer and coating efficiencies are high for these procedures, resulting in little wasted Fe(III).

The addition of NSZVI to CER and GAC using the procedures did not alter the surfaces of these media markedly. For example, the BET area of GAC remained essentially the same following NSZVI addition, and most (˜85%) of the CER surface remain uncovered by NSZVI after reduction.

Coating NSZVI adds additional functions to GAC and CER without significantly affecting the capacities of these media to remove contaminants that they are intended to treat. GAC and CER are among the most common granular filter media because they can sorb a broad range of organic and metallic (cationic) contaminants in water.

### Example 2

The disinfection effectiveness of the NSZVI coated GAC and CER media on microorganisms was measured.

MS2 and T1, which are both bacteriophage or bacterial viruses, are both F-specific RNA bacteriophage and their structure resembles many human enteric viruses and have been used as surrogates for human enteric viruses. MS2 (ATCC 15597-B1) was grown and assayed using E. coli (ATCC23631) as the host organism. T1 (ATTCC-11303 B) was assayed with E. coli CN13 (ATCC 700609) as the host. The methodology for growth, detection and enumeration of F-specific RNA bacteriophage was based on ISO Method 10705 (ISO, 1995) and Appendix A of the US EPA Ultraviolet Disinfection Guidance Manual (November, 2006).

Additional experiments were conducted using fecal coliform and pure culture E. coli. The assay for fecal coliform followed the HydroQual Standard Operation Protocol (SOP) #33 (certified by the State of New Jersey). A known volume of water sample was filtered through a 0.45 μm pore size filter. The filter was placed onto a M-FC agar plate and incubated 24+/−2 h at 44.5+/−0.2° C. Blue shaded colonies on the M-FC agar plate were markers for the fecal coliform group. Colonies were counted by a 10 to 15 magnification with a fluorescent light source.

The assay for fecal coliform followed the HydroQual Standard Operation Protocol (SOP) #33 (certified by the State of New Jersey). The bacterial produced red colonies with a metallic sheen within 24 hours incubation at 35° C. on Endo-type medium. A known volume of water sample was filtered through a 0.45 μm pore size filter. The filter was placed onto a M-FC agar plate and incubated 24+/−2 h at 35.0+/−0.5° C. Typical pink to dark red colonies with a metallic sheen were formed on the M-Endo Agar and were counted by a 10 to 15 magnification with a fluorescent light source.

Microorganism solutions were each prepared using a uniform concentration (1×10⁶ pfu/mL) using artificial groundwater (AGW), which contained 2.0 mM of NaHCO₃ (ionic strength 2 mM). After autoclaving and degassing, the pH of the AGW was adjusted to 7.0 using 1N NaOH or 1N HCl solution.

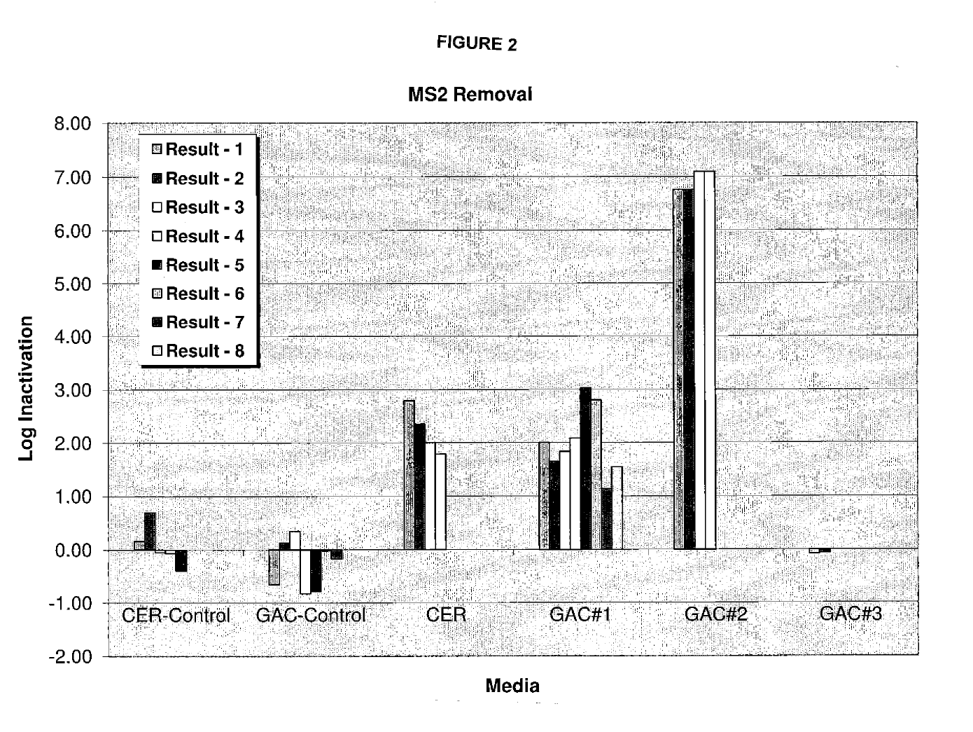

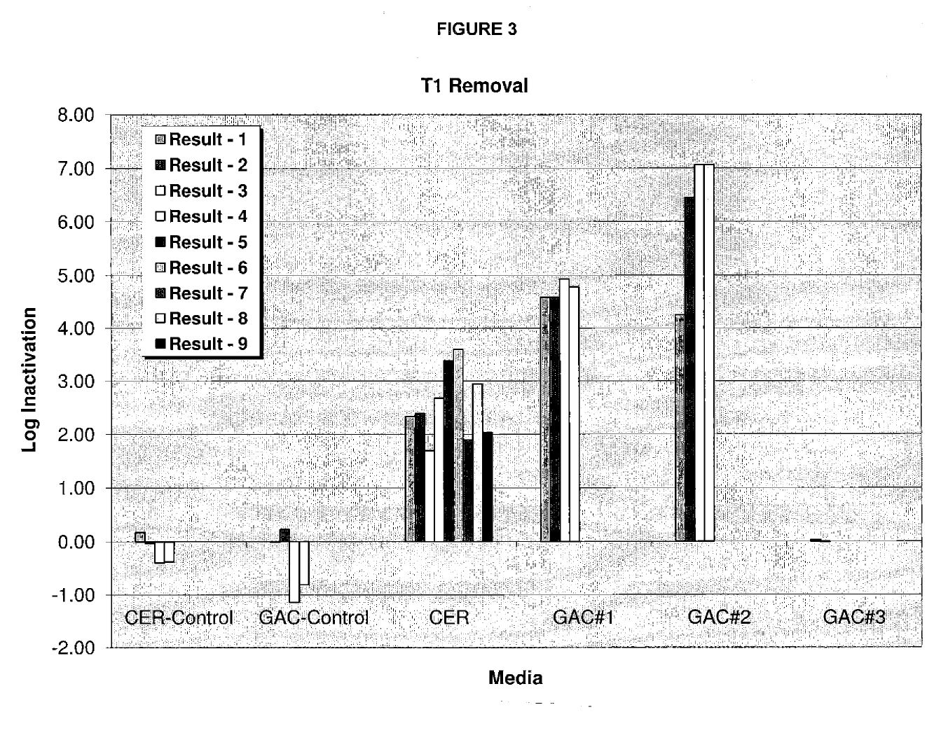

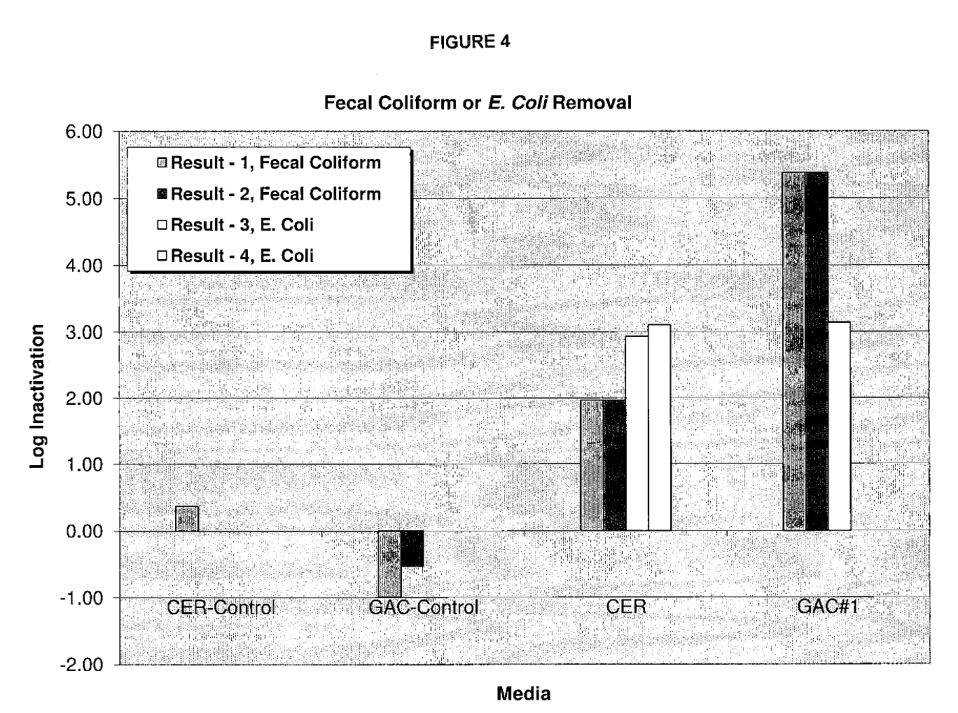

A sample of the initial microorganism solution was taken for analysis before the testing the coated filter media. The solution was added (25 mL) to an amber glass batch reactor containing 0.5 gram of NSZVI coated filter media. All of the filter media coated with NSZVI in Example 1 were tested. The batch reactors were placed on a shaker table (Eberbach Corporation) at a constant speed of 170 rpm for a period of 10 minutes. Samples were collected immediately after shaking by passing through a 1 μm syringe filters (Whatman) and transferred to amber glass bottles for temporary storage prior to analysis. Controls were prepared identically but with uncoated GAC and CER subjected to the same test procedures. Results of MS2, T1 and fecal coliform and E. coli removal are shown respectively in FIGS. 2, 3 and 4. In each of the tests the NSZVI coated CER and GAC removed significantly more of the MS2, T1, fecal coliform and E. coli in comparison to the uncoated CER and GAC controls.

### Example 3

The removal of chemicals contaminants from water by the NSZVI coated GAC and CER media was measured.

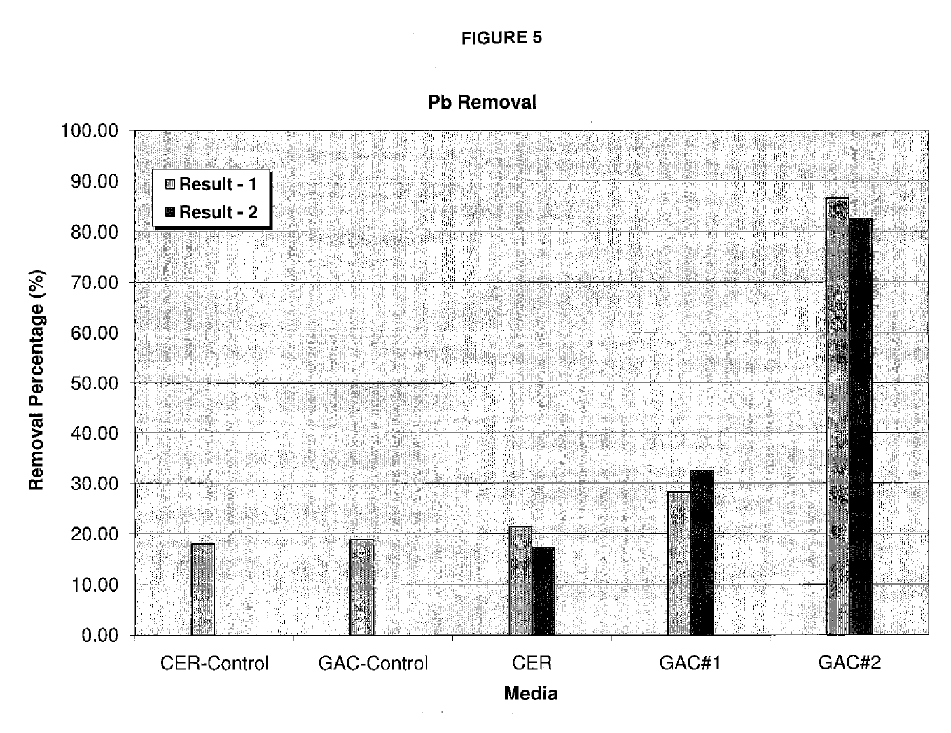

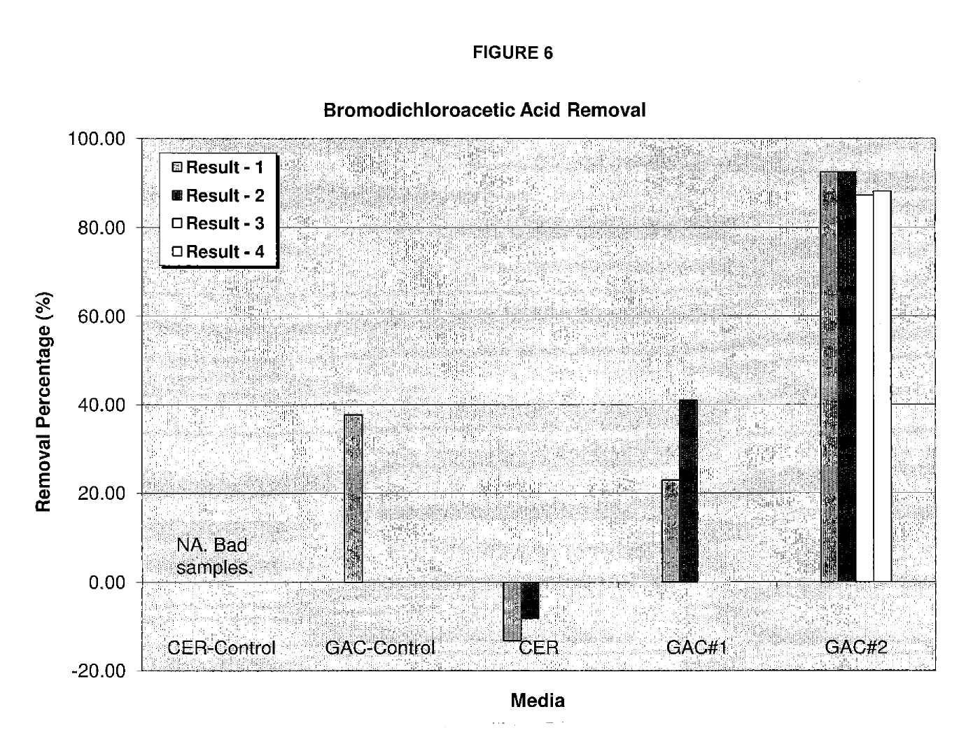

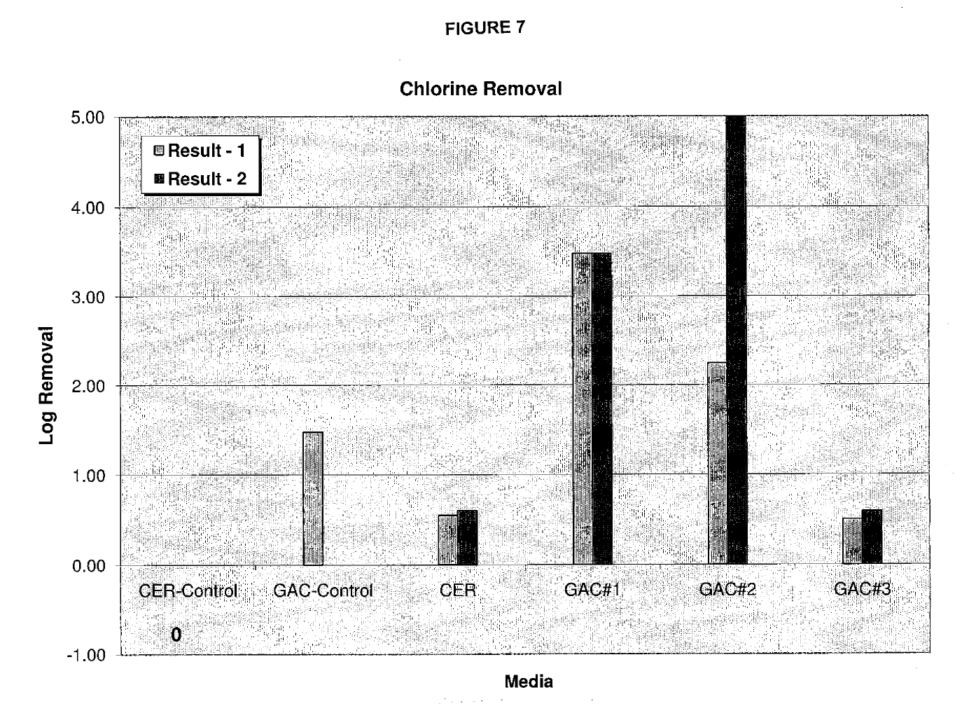

Solutions of chemical contaminants were prepared in uniform concentrations using distilled water. The compounds were PbCl₂ (99% purity), bromodichloroacetate (99% purity) and NaOCl (5% chlorine). All of the filter media coated with NSZVI in Example 1 were tested using the same test procedure as in Example 2. Samples for chlorine removal were analyzed immediately after the test at HydrorQual's lab using a chlorine meter (HACH, model CN-80) with HACHDPD total chlorine reagent. Quantification of lead was performed by Columbia “Analytical Services (CAS) using EPA Method 6010B (Inductively Coupled Plasma-Atomic Emission Spectrometry). Quantification of bromodichloroacetic acid was performed by CAS using EPA Method 552.2 FIGS. 5-7 show the removal of these chemical contaminates by the NXZVI coated GAC and CER media in comparison to the controls of uncoated GAC and CER. In general, the GAC coated media removed more chemical contaminants in comparison to the GAC control.

### ABBREVIATIONS

GAC Granular activated carbon
NSZV Nano-sized zero-valent
NSZVI Nano-sized zero-valent iron
CER Cation-exchange resin

### POU Point-of-use

BET Braunauer-Emmett-Teller

1. A filtration medium, comprising a base filtration medium that is at least partially-coated with zero-valent metal particles, wherein said zero-valent metal particles are in a size range of from about 1 to about 1,000 nm.

2. The filtration medium as recited in claim 1, wherein said base filtration medium is selected from the group consisting of anthracite, sand, gravel, activated carbon, zeolite, clay, diatomaceous earth, garnet, ilmenite, zircon, charcoal, ion exchange resin, silica gel, titania, black carbon, and mixtures thereof.

3. The filtration medium as recited in claim 1, wherein said filtration is fully-coated with said NSZV particles.

4. The filtration medium as recited in claim 1, wherein the filtration medium is partially-coated, and wherein the coated surface area of said filtration medium particles as a percentage of total available coatable filtration medium surface area is in the range of from about 0.25% to about 35%.

5. The filtration medium as recited in claim 1, wherein the amount of said NSZV metal coated on said filtration medium, as a percentage of the total of said NSZV metal and said base filtration medium, is in the range of from about 0.2% to about 35%.

6. The filtration medium as recited in claim 1, wherein said NSZV metal particles are coated on said base filtration medium at discrete locations on said base filtration medium particles.

7. The filtration medium as recited in claim 1, wherein said NSZV particles coated on said base filtration medium exist substantially as individual particles, as individual particles and as cluster of particles, and/or as cluster of particles.

8. The filtration medium as recited in claim 1, wherein said filtration medium comprises at least one base filtration medium, and said NSZV metal particles coated on said base filtration medium comprises at least one NSZV metal element.

9. The filtration medium as recited in claim 1, wherein said NSZV metal is iron or aluminum.

10. A process for preparing a NSZV metal-coated filtration medium, comprising the steps of:
(a) providing a base filtration medium;
(b) providing aqueous solution of said metal in an oxidation state greater than zero;
(c) contacting said aqueous solution of said metal in said oxidation state that is greater than zero, with said base filtration medium for a length of time that is sufficient for the required amount of said metal to be retained by said base filtration medium;
(d) optionally, washing said base filtration medium comprising said metal in an oxidation state greater than zero with water;
(e) reducing said metal in an oxidation state greater than zero residing on said base filtration medium to an oxidation state of zero; and
(f) optionally, drying said base filtration medium comprising said NSZV metal coated on its surface.

11. The process as recited in claim 10, wherein said metal is iron and said aqueous solution comprises iron in an oxidation state of +3.

12. The process as recited in claim 11, wherein said iron ion is derived from Fe(NO3)3 or FeCl3.

13. The process as recited in claim 10, wherein said metal is aluminum and said aqueous solution comprises iron in an oxidation state of +3.

14. The process as recited in claim 13, wherein said iron ion is derived from Al(NO3)3 or AlCl3.

15. The process as recited in claim 10, wherein said reducing in step (e) is wet reduction or is thermal reduction.

16. The process as recited in claim 15, wherein said reduction is wet reduction and the reducing agent is sodium borohydride.

17. The process as recited in claim 15, wherein said reduction is thermal reduction and the reducing agent is hydrogen.

18. The process as recited in claim 16, wherein said base filtration medium is cationic exchange resin.

19. The process as recited in claim 17, wherein said base filtration medium is granular activated carbon.

20. A system for removing microbiological impurities from water, wherein said system comprises a conduit or a container comprising a filtration medium comprising a base filtration medium that is at least partially-coated with zero-valent metal particles, wherein said zero-valent metal particles are in a size range of from about 1 to about 1,000 nm.

21. The system as described in claim 20, wherein said system is continuous-flow system.

22. The system as described in claim 20, wherein said system is a batch system.

23. The system as described in claim 20, wherein said system comprises at least one layer of filtration medium that comprises base filtration medium that is coated with NSZV metal particles.

24. The system as described in claim 20, wherein said system comprises at least a portion of its filtration medium that is a mixture of NSZV metal-coated filtration medium and uncoated base filtration medium.

25. The system as described in claim 20, wherein said system comprises at least one layer of filtration medium that comprises base filtration medium that is coated with NSZV metal particles and at least a portion of its filtration medium that is a mixture of NSZV metal-coated filtration medium and uncoated base filtration medium.

26. The system as recited in claim 20, wherein said base filtration medium is selected from the group consisting of anthracite, sand, gravel, activated carbon, zeolite, clay, diatomaceous earth, garnet, ilmenite, zircon, charcoal, ion exchange resin, silica gel, titanic, black carbon, and mixtures thereof.

27. The system as recited in claim 20, wherein from about 0.5% to about 35% of all said filtration medium particles by number in said system are at least partially-coated with NSZV metal.

28. The system as recited in claim 20, wherein said base filtration medium is partially-coated, and wherein the coated surface area of said filtration medium particles as a percentage of total available coatable filtration medium surface area of filtration medium particles in said system is in the range of from about 0.25% to about 35%.

29. The system as recited in claim 20, wherein the amount of said NSZV metal coated on said filtration medium, as a percentage of the total of said NSZV metal and said base filtration medium in said system, is in the range of from about 0.2% to about 35%.

30. A system as recited in claim 20, wherein said filtration medium comprises at least one base filtration medium, and said NSZV metal particles coated on said base filtration medium comprises at least one NSZV metal element.

31. The system as recited in claim 20, wherein said NSZV metal is iron or aluminum.

32. The system as recited in claim 20, wherein said system is a bag or a pouch comprising said filtration medium.

33. The system as recited in claim 20, wherein said system is portable.

34. The system as recited in claim 20, wherein said system reduces viruses in water by at least 50%, said system comprising either a conduit or a container packed with base filtration medium wherein at least a portion of said base filtration medium is at least partially-coated with NSZV metal particles;
wherein said NSZV metal particles coated on said base filtration medium comprise an oxide, a hydroxide, and/or an oxyhydroxide coating on the surface of said NSZV metal particles through corrosion in water;
wherein said element is selected from the group consisting of iron and aluminum.

35. The system as recited in claim 34, wherein more than 99.99% of said viruses are removed from water.

36. The system as recited in claim 34, wherein more than 99.9999% of said viruses are removed from water.

37. A process for removing microbiological impurities from fluids, comprising contacting said fluid with a filtration medium in a conduit or container, wherein said filtration medium comprises a base filtration medium that is at least partially coated with zero-valent metal particles, wherein said zero-valent metal particles are in a size range of from about 1 to about 1,000 nm.

38. The process as recited in claim 37, wherein said fluid is water.

39. The process as recited in claim 8, wherein said microbiological impurities comprise viruses.

40. The process as recited in claim 39, wherein said water comprises at least one of surface water, drinking water, wastewater, backwash water, irrigation water, food-processing water, ballast water, spring and ground water, recreational waters, leachate, medical waste, laboratory waste, pharmaceutical waste, and other aqueous wastes.

41. The process as recited in claim 37, wherein said liquid is stationary in said conduit or container.

42. The process as recited in claim 37, wherein said liquid flows continuously through said conduit or said container.

43. The process as recited in claim 42, wherein said liquid flows through said conduit or said container at a linear velocity of from about 0.1 cm/hr to about 10 m/min.

44. The process as recited in claim 37, wherein the residence time of the liquid in said conduit or said container is from about 0.05 s to about 48 hours.

45. The process as recited in claim 37, wherein liquid comprises a virus and wherein said virus concentration is reduced by about 50%.

46. The process as recited in claim 37, further comprising treating said liquid with a chemical disinfectant, irradiation, or filtration.

47. The system as recited in claim 37, wherein more than 99.99% of said viruses are removed from water.

48. The system as recited in claim 37, wherein more than 99.9999% of said viruses are removed from water.

49. The final water resulting from the process for removing microbiological impurities from water, comprising contacting said water with a filtration medium in a conduit or container, wherein said filtration medium comprises a base filtration medium that is at least partially coated with zero-valent metal particles, wherein said zero-valent metal particles are in a size range of from about 1 to about 1,000 nm.
